(19) United States
(12) Patent Application Publication
(10) Pub. No.: US 2026/0135469 A1
(43) Pub. Date: May 14, 2026

(54) DRIVING CIRCUIT

(71) Applicant: Delta Electronics, Inc., Taoyuan City (TW)

(72) Inventors: Shaopeng Han, Shanghai (CN); Yanbing Xia, Shanghai (CN); Ke Sun, Shanghai (CN)

(21) Appl. No.: 19/305,286

(22) Filed: Aug. 20, 2025

(30) Foreign Application Priority Data
Sep. 13, 2024 (CN) 202411287710.7

(51) Int. Cl. H02M 1/088; H02M 3/335

(52) U.S. Cl. CPC H02M 1/088; H02M 3/3353

(57) ABSTRACT

A driving circuit includes a driver, a negative voltage generating circuit and a negative voltage control circuit. The driver receives a first control signal and generates a first driving signal. The negative voltage generating circuit includes a first terminal, a second terminal, a first resistor, a first capacitor and a second resistor. A first switching signal is output from the second terminal to control the operation of one part of a plurality of main switches. The negative voltage control circuit includes a diode and an auxiliary switch. When the first control signal is transitioned from a high level state to a low level state, the first switching signal is transitioned from a positive voltage to a negative voltage. Following the dead time, the first switching signal is transitioned from the negative voltage to a zero voltage.

### CROSS-REFERENCE TO RELATED APPLICATIONS

This application claims priority to China Patent Application No. 202411287710.7 filed on Sep. 13, 2024. The entire contents of the above-mentioned patent application are incorporated herein by reference for all purposes.

### FIELD OF THE INVENTION

The present disclosure relates to a driving circuit, and more particularly to a driving circuit for driving a switching circuit.

### BACKGROUND OF THE INVENTION

A power conversion device typically includes a switching circuit, such as a bridge-type switching circuit. The operation of the switching circuit achieve energy conversion. Furthermore, the power conversion device further includes a driving circuit configured to drive and control the operation of the switching circuit.

For the bridge-type switching circuit, conventional driving circuit usually provides complementary first and second driving signals. The first driving signal is used to drive the upper switch of the first bridge arm and the lower switch of the second bridge arm. The second driving signal is used to drive the lower switch of the first bridge arm and the upper switch of the second bridge arm.

The conventional driving circuit supplies a positive driving voltage (e.g., 0V to +6V). When the switches in the bridge-type switching circuit are gallium nitride (GaN) devices, technical issues arise due to their higher switching frequencies and lower gate threshold voltages Vth (approximately 1V). During rapid turn-off transitions, parasitic oscillations may occur, especially in high-noise environments, which may erroneously turn on the switches, increasing the risk of failure.

To address the above drawbacks, some driving circuits employ negative driving voltage (e.g., a driving voltage range between-3 V and +6V). This ensures that the gate voltage remain below the turn-on threshold of the GaN devices even with noise-induced oscillations, thereby reducing false triggering probability. However, this approach introduces new issues. For example, the prolonged operation under the negative driving voltage may cause additional losses, such as reverse conduction loss, which degrade the overall efficiency of the power conversion device.

Therefore, it is important to develop an improved driving circuit to overcome the drawbacks of the conventional technologies.

### SUMMARY OF THE INVENTION

The present disclosure provides a driving circuit. The driving circuit includes a negative voltage generating circuit configured to generate a negative driving voltage and a negative voltage control circuit configured to control the negative driving voltage. This configuration ensures reliable switch turn-off via the negative driving voltage while rapidly transitioning the negative driving voltage to a zero voltage. Consequently, the reliability of driving the switch is enhanced without efficiency penalty.

In accordance with an aspect of the present disclosure, a driving circuit for a power conversion device is provided. The power conversion device includes a switching circuit and a controller. The switching circuit includes a plurality of main switches. The controller provides a first control signal and a second control signal to the driving circuit. The first control signal and the second control signal are complementary to each other. A dead time exists between the first control signal and the second control signal. The driving circuit includes a first driver, a first negative voltage generating circuit and a first negative voltage control circuit. The first driver receives the first control signal and generates a first driving signal. The first negative voltage generating circuit includes a first terminal, a second terminal, a first resistor, a first capacitor and a second resistor. The first terminal is electrically connected to an output terminal of the first driver. The first resistor and the first capacitor are electrically connected in series between the first terminal and the second terminal to form a first series branch. The second resistor is connected in parallel with the first series branch. A first switching signal is output from the second terminal of the first negative voltage generating circuit to control the operation of one part of the plurality of main switches of the switching circuit. The first negative voltage control circuit includes a first diode and a first auxiliary switch. The first diode and the first auxiliary switch are electrically connected in series between the second terminal of the first negative voltage generating circuit and a ground terminal. When the first control signal is transitioned from a high level state to a low level state, the first switching signal is transitioned from a positive voltage to a negative voltage by the first negative voltage generating circuit. Following the dead time, the first switching signal is transitioned from the negative voltage to a zero voltage by the first negative voltage control circuit.

The above contents of the present disclosure will become more readily apparent to those ordinarily skilled in the art after reviewing the following detailed description and accompanying drawings, in which:

### BRIEF DESCRIPTION OF THE DRAWINGS

FIG. 1 is a schematic circuit diagram illustrating the circuitry topology of a power conversion device with a driving circuit according to a first embodiment of the present disclosure;

FIG. 2 is a schematic circuit diagram illustrating the detailed circuitry topology of the driving circuit shown in FIG. 1;

FIG. 3 is a schematic timing waveform diagram illustrating associated signals processed by the driving circuit shown in FIG. 1;

FIG. 4 is a schematic circuit diagram illustrating the detailed circuitry topology of a power conversion device with a driving circuit according to a second embodiment of the present disclosure;

FIG. 5 is a schematic circuit diagram illustrating the circuitry topology of a power conversion device with a driving circuit according to a third embodiment of the present disclosure;

FIG. 6 is a schematic timing waveform diagram illustrating associated signals processed by the driving circuit shown in FIG. 5; and

FIG. 7 is a schematic circuit diagram illustrating the circuitry topology of a power conversion device with a driving circuit according to a fourth embodiment of the present disclosure.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

In this context, the terms “first”, “second”, etc. do not specifically refer to order or sequence, nor are they used to limit this application. They are only used to distinguish between elements or operations described by the same technical terms. The terms “including”, “comprising”, “having” and “containing” used in this context are all open terms, which mean including but not limited to. Unless otherwise expressly specified or limited, the term “connected” and the term “coupled” should be understood in a broad sense. For example, two or more elements are in direct physical or electrical contact, or two or more elements are in indirect physical or electrical contact with each other.

The following is a detailed description of some embodiments of the present application in conjunction with the accompanying drawings. In the absence of conflict, the following embodiments and features in the embodiments may be combined with each other, and the same or similar concepts or processes may not be described in detail in some embodiments.

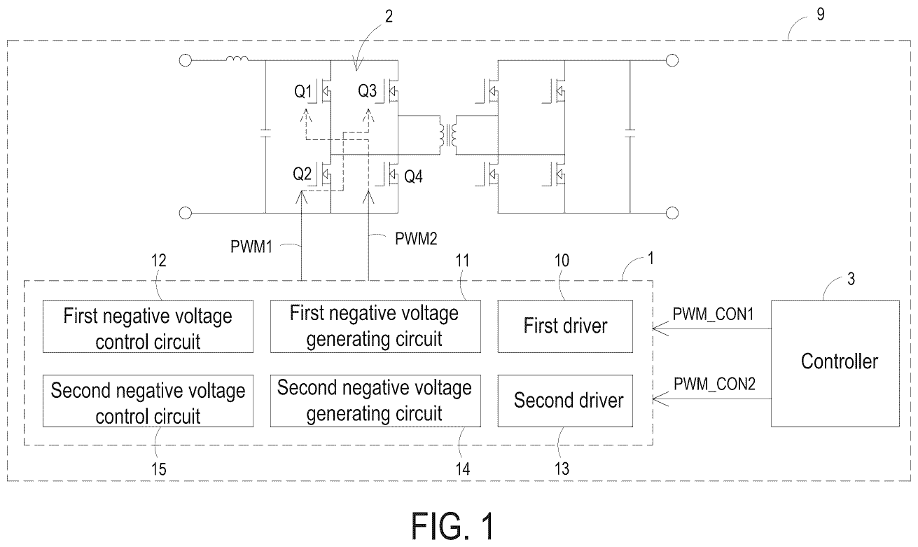

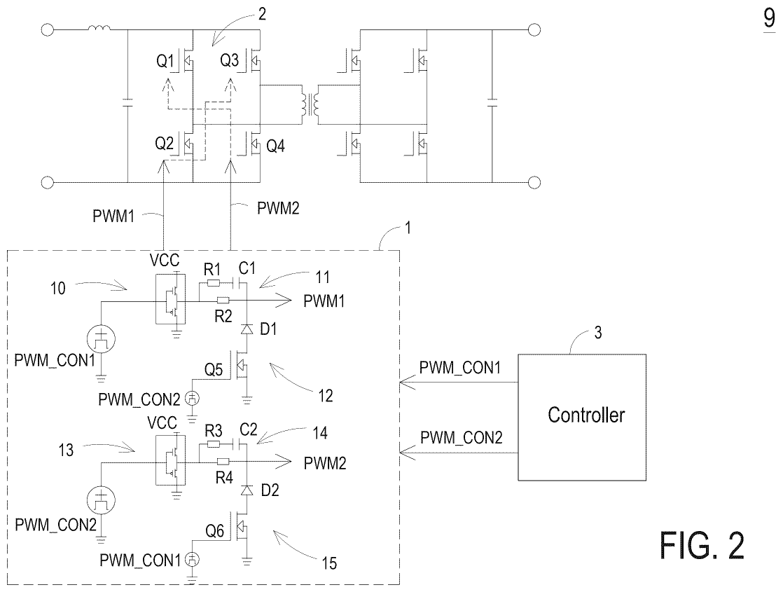

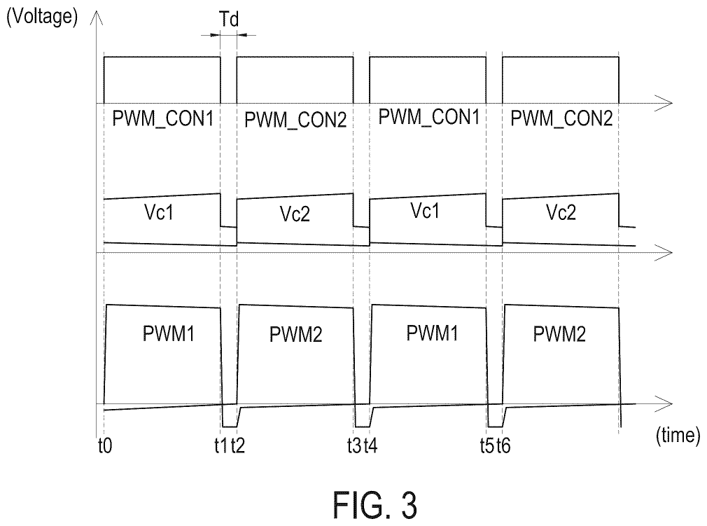

Please refer to FIGS. 1, 2 and 3. FIG. 1 is a schematic circuit diagram illustrating the circuitry topology of a power conversion device with a driving circuit according to a first embodiment of the present disclosure. FIG. 2 is a schematic circuit diagram illustrating the detailed circuitry topology of the driving circuit shown in FIG. 1. FIG. 3 is a schematic timing waveform diagram illustrating associated signals processed by the driving circuit shown in FIG. 1.

The driving circuit 1 may be applied to a power conversion device 9. The power conversion device 9 further includes a switching circuit 2 and a controller 3. For example, the controller 3 includes a digital controller and an analog controller.

The switching circuit 2 includes a plurality of main switches. For example, as shown in FIG. 2, the switching circuit 2 includes a first upper switch Q1, a first lower switch Q2, a second upper switch Q3 and a second lower switch Q4. The first upper switch Q1 and the first lower switch Q2 are electrically connected in series to form a first switching bridge arm. The second upper switch Q3 and the second lower switch Q4 are electrically connected in series to form a second switching bridge arm. The first switching bridge arm and the second switching bridge arm are electrically connected to each other in parallel.

The controller 3 provides a first control signal PWM_CON1 and a second control signal PWM_CON2 to the driving circuit 1. The first control signal PWM_CON1 and the second control signal PWM_CON2 are complementary to each other. In addition, there is a dead time Td between the first control signal PWM_CON1 and the second control signal PWM_CON2. When the first control signal PWM_CON1 is in the high level state, the second control signal PWM_CON2 is in the low level state. When the second control signal PWM_CON2 is in the high level state, the first control signal PWM_CON1 is in the low level state. In the dead time Td, the first control signal PWM_CON1 and the second control signal PWM_CON2 are both in the low level state. In some embodiments, the plurality of main switches are gallium nitride switches.

According to the first control signal PWM_CON1 and the second control signal PWM_CON2, the driving circuit 1 generates a first switching signal PWM1 and a second switching signal PWM2 to control the operation of the switching circuit 2.

The driving circuit 1 includes a first driver 10, a first negative voltage generating circuit 11 and a first negative voltage control circuit 12. The first driver 10 receives the first control signal PWM_CON1 and generates a first driving signal according to the first control signal PWM_CON1. In an embodiment, the first driver 10 includes a first driving switch and a second driving switch. The control terminal of the first driving switch and the control terminal of the second driving switch are electrically connected to the controller 3 to receive the first control signal PWM_CON1. The first conducting terminal of the first driving switch is electrically connected to the second conducting terminal of the second driving switch. The second conducting terminal of the first driving switch is electrically connected to a voltage source VCC. The first conducting terminal of the second driving switch is electrically connected to the ground terminal.

The first negative voltage generating circuit 11 includes a first terminal, a second terminal, a first resistor R1, a first capacitor C1 and a second resistor R2. The first terminal of the first negative voltage generating circuit 11 is electrically connected to the output terminal of the first driver 10 to receive the first driving signal. The first resistor R1 and the first capacitor C1 are electrically connected in series between the first terminal and the second terminal of the first negative voltage generating circuit 11 to form a first series branch. The second resistor R2 is connected in parallel with the first series branch. The first switching signal PWM1 is output from the second terminal of the first negative voltage generating circuit 11 to control the operation of one part of the plurality of main switches of the switching circuit 2. For example, the operation of the first lower switch Q2 and the second upper switch Q3 are controlled by the first switching signal PWM1.

The first negative voltage control circuit 12 includes a first diode D1 and a first auxiliary switch Q5. The first diode D1 and the first auxiliary switch Q5 are electrically connected in series between the second terminal of the first negative voltage generating circuit 11 and the ground terminal.

The first terminal of the first auxiliary switch Q5 is electrically connected to the anode of the first diode D1. The second terminal of the first auxiliary switch Q5 is electrically connected to the ground terminal. The control terminal of the first auxiliary switch Q5 receives the second control signal PWM_CON2. The cathode of the first diode D1 is electrically connected to the second terminal of the first negative voltage generating circuit 11.

In an embodiment, the driving circuit 1 further includes a second driver 13, a second negative voltage generating circuit 14 and a second negative voltage control circuit 15. The second driver 13 receives the second control signal PWM_CON2 and generates a second driving signal according to the second control signal PWM_CON2. In an embodiment, the second driver 13 includes a third driving switch and a fourth driving switch. The control terminal of the third driving switch and the control terminal of the fourth driving switch are electrically connected to the controller 3 to receive the second control signal PWM_CON2. The first conducting terminal of the third driving switch is electrically connected to the second conducting terminal of the fourth driving switch. The second conductive terminal of the third driving switch is electrically connected to the voltage source VCC. The first conducting terminal of the fourth driving switch is electrically connected to the ground terminal.

The second negative voltage generating circuit 14 includes a third terminal, a fourth terminal, a third resistor R3, a second capacitor C2 and a fourth resistor R4. The third terminal of the second negative voltage generating circuit 14 is electrically connected to the output terminal of the second driver 13 to receive the second driving signal. The third resistor R3 and the second capacitor C2 are electrically connected in series between the third terminal and the fourth terminal of the second negative voltage generating circuit 14 to form a second series branch. The fourth resistor R4 is connected in parallel with the second series branch. The second switching signal PWM2 is output from the fourth terminal of the second negative voltage generating circuit 14 to control the operation of another part of the plurality of main switches of the switching circuit 2. For example, the operation of the first upper switch Q1 and the second lower switch Q4 are controlled by the second switching signal PWM2.

The second negative voltage control circuit 15 includes a second diode D2 and a second auxiliary switch Q6. The second diode D2 and the second auxiliary switch Q6 are electrically connected in series between the fourth terminal of the second negative voltage generating circuit and the ground terminal. The first terminal of the second auxiliary switch Q6 is electrically connected to the anode of the second diode D2. The second terminal of the second auxiliary switch Q6 is electrically connected to the ground terminal. The control terminal of the second auxiliary switch Q6 receives the first control signal PWM_CON1. The cathode of the second diode D2 is electrically connected to the fourth terminal of the second negative voltage generating circuit 14.

Please refer to FIG. 3. In the time interval between the time point t0 and the time point t1, the first control signal PWM_CON1 is in the high level state. The first driving switch of the first driver 10 is activated to provide the first switching signal PWM1. Meanwhile, the first capacitor C1 is charged via the first resistor R1, causing the capacitor voltage Vc1 of the first capacitor C1 to increase gradually. Furthermore, one part of the plurality of main switches of the switching circuit 2 are driven through the second resistor R2, specifically turning on the first lower switch Q2 and the second upper switch Q3. Consequently, the following formula may be obtained:

$$V\_PWM \_CON 1 = V c 1 + V gs$$

In the above formula, V_PWM_CON1 is the voltage value of the first control signal PWM_CON1, Vc1 is the capacitor voltage of the first capacitor C1, and Vgs is the gate-source voltage of the first lower switch Q2 or the second upper switch Q3, wherein the gate-source voltage Vgs is the first switching signal PWM1. Obviously, the first switching signal PWM1 is a positive voltage in this time interval.

The time interval between the time point t1 and the time point t2 is the dead time Td of the first control signal PWM_CON1 and the second control signal PWM_CON2. Moreover, the first control signal PWM_CON1 and the second control signal PWM_CON2 are in the low level state. Since the capacitor voltage can not change instantaneously, the first capacitor C1 discharges slowly. Meanwhile, the gate-to-source voltages of the first lower switch Q2 and the second upper switch Q3 turn negative. In addition, the amplitude of the gate-source voltage is equal to the capacitor voltage of the first capacitor C1 and is expressed by the following formula:

$$- V c 1 + V gs$$

In the above formula, the first switching signal PWM1 is a negative voltage.

When the first control signal PWM_CON1 is transitioned from a high level signal to a low level signal, the first switching signal PWM1 (i.e., the gate-source voltage) is transitioned from a positive voltage to a negative voltage by the first negative voltage generating circuit 11.

In the time interval between the time point t2 and the time point t3, the second control signal PWM_CON2 is in the high level state, and the first control signal PWM_CON1 is continuously maintained in the low level state. In addition to driving the first upper switch Q1 and the second lower switch Q4, the second control signal PWM_CON2 also drives the first auxiliary switch Q5, forming a closed loop through the first auxiliary switch Q5, the first diode D1, the first lower switch Q2 and the second upper switch Q3. This pulls down the gate-source voltages of the first lower switch Q2 and the second upper switch Q3 to near zero voltage. Moreover, the first diode D1 may prevent abrupt discharge of the capacitor voltage Vc1 of the first capacitor C1, suppressing oscillations. Consequently, the main switches of the switching circuit 2 may avoid false turn-on. Following the dead time Td, the second control signal PWM_CON2 is transitioned from the low level state to the high level state. Meanwhile, the first auxiliary switch Q5 is turned on, and the first switching signal PWM1 is transitioned from a negative voltage to a zero voltage. In this context, the term “zero voltage” where the first switching signal PWM1 is transitioned from a negative voltage to a zero voltage means that the voltage value of the first switching signal PWM1 is close to zero or equal to zero. That is, a small deviation is allowed.

In the time interval between the time point t3 and the time point t4, the first upper switch Q1 and the second lower switch Q4 cooperate with the second auxiliary switch Q6 to repeat the operations similar to those in the time interval between the time point t1 and the time point t2. Consequently, a switching cycle is completed.

Since the first negative voltage generating circuit 11 of the driving circuit 1 generates the first switching signal PWM1 of the negative voltage to turn off the first lower switch Q2 and the second upper switch Q3, the first lower switch Q2 and the second upper switch Q3 may be prevented from turning on erroneously. Since the first lower switch Q2 and the second upper switch Q3 are turned off in response to the negative voltage, the first negative voltage control circuit 12 of the driving circuit 1 can promptly pull the first switching signal PWM1 to zero, reducing the additional loss (reverse conduction loss) and enhancing the conversion efficiency of the power conversion device 9.

The operations of the second driver 13, the second negative voltage generating circuit 14 and the second negative voltage control circuit 15 are similar to those of the first driver 10, the first negative voltage generating circuit 11 and the first negative voltage control circuit 12, and not redundantly described herein.

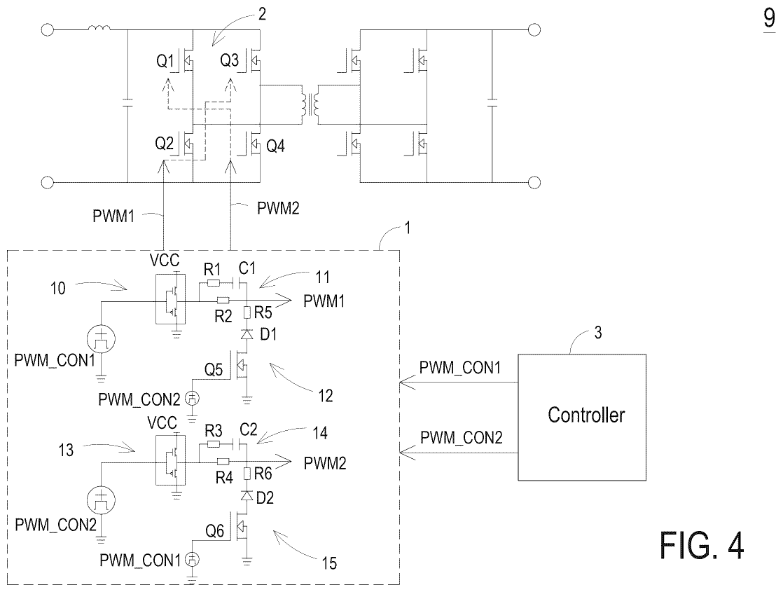

FIG. 4 is a schematic circuit diagram illustrating the detailed circuitry topology of a power conversion device with a driving circuit according to a second embodiment of the present disclosure. In an embodiment, the first negative voltage control circuit 12 further includes a fifth resistor R5. The fifth resistor R5 is electrically connected in series with the first diode D1 and the first auxiliary switch Q5. Due to the installation of the fifth resistor R5, the slope during the transition of the first switching signal PWM1 from negative voltage to zero voltage can be adjusted to prevent voltage oscillation.

The second negative voltage control circuit 15 further includes a sixth resistor R6. The sixth resistor R6 is electrically connected in series with the second diode D2 and the second auxiliary switch Q6. Due to the installation of the sixth resistor R6, the slope during the transition of the second switching signal PWM2 from the negative voltage to the zero voltage can be adjusted to prevent voltage oscillation.

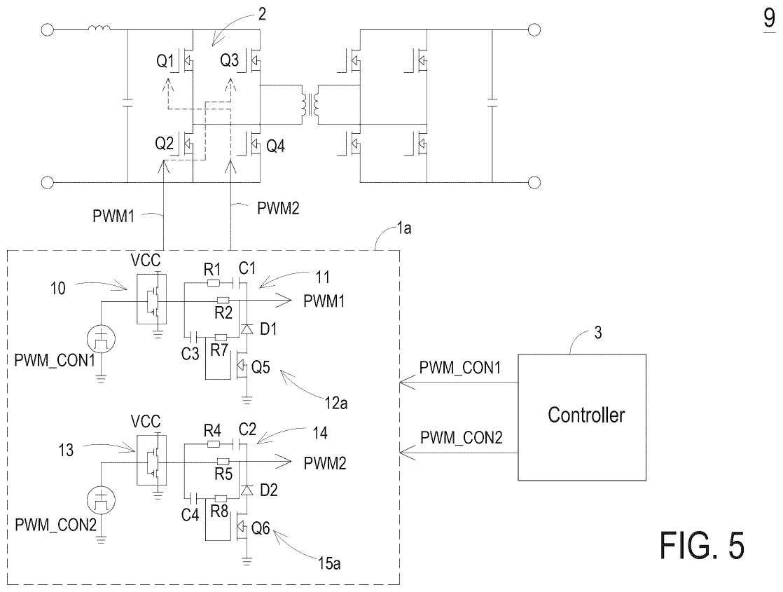

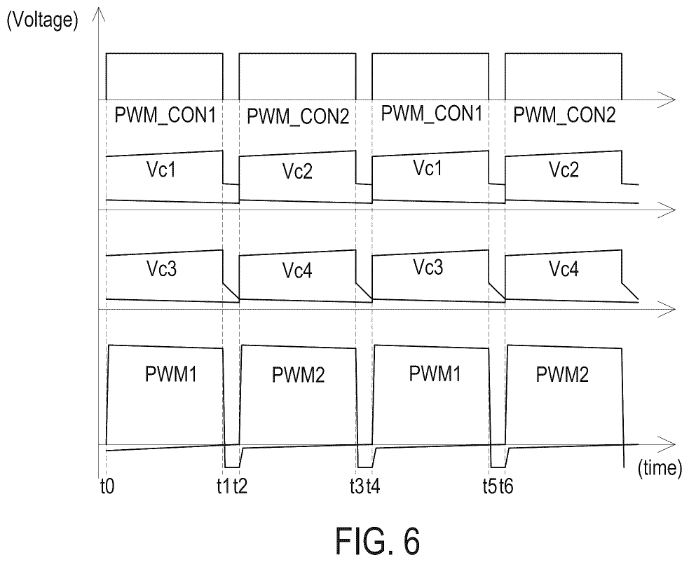

Please refer to FIGS. 5 and 6. FIG. 5 is a schematic circuit diagram illustrating the circuitry topology of a power conversion device with a driving circuit according to a third embodiment of the present disclosure. FIG. 6 is a schematic timing waveform diagram illustrating associated signals processed by the driving circuit shown in FIG. 5. The circuitry topology and the operation of the driving circuit 1a are similar to those of the driving circuit 1, and not redundantly described herein. When compared with the driving circuit 1 shown in FIG. 2, the first negative voltage control circuit 12a in the driving circuit 1a of this embodiment is distinguished. In this embodiment, the first negative voltage control circuit 12a includes a first diode D1, a first auxiliary switch Q5, a seventh resistor R7 and a third capacitor C3.

The first terminal of the first auxiliary switch Q5 is electrically connected to the anode of the first diode D1. The second terminal of the first auxiliary switch Q5 is electrically connected to the ground terminal. The control terminal of the first auxiliary switch Q5 is electrically connected to the first terminal of the third capacitor C3 and the first terminal of the seventh resistor R7. The cathode of the first diode D1 is electrically connected to the second terminal of the first negative voltage generating circuit 11. The second terminal of the third capacitor C3 is electrically connected to the first terminal of the first negative voltage generating circuit 11. The second terminal of the seventh resistor R7 is electrically connected to the second terminal of the first negative voltage generating circuit 11.

When compared with the driving circuit 1 shown in FIG. 2, the second negative voltage control circuit 15a in the driving circuit 1a of this embodiment is distinguished. In this embodiment, the second negative voltage control circuit 15a of the driving circuit 1a includes a second diode D2, a second auxiliary switch Q6, an eighth resistor R8 and a fourth capacitor C4. The first terminal of the second auxiliary switch Q6 is electrically connected to the anode of the second diode D2. The second terminal of the second auxiliary switch Q6 is electrically connected to the ground terminal. The control terminal of the second auxiliary switch Q6 is electrically connected to the first terminal of the fourth capacitor C4 and the first terminal of the eighth resistor R8. The cathode of the second diode D2 is electrically connected to the fourth terminal of the second negative voltage generating circuit 14. The second terminal of the fourth capacitor C4 is electrically connected to the third terminal of the second negative voltage generating circuit 14. The second terminal of the eighth resistor R8 is electrically connected to the fourth terminal of the second negative voltage generating circuit 14.

Please refer to FIG. 6. In the time interval between the time point t0 and the time point t1, the first control signal PWM_CON1 is in the high level state. The first driving switch of the first driver 10 is activated to provide the first switching signal PWM1. Meanwhile, the first capacitor C1 is charged via the first resistor R1, causing a capacitor voltage Vc1 of the first capacitor C1 to increase gradually. Furthermore, one part of the plurality of main switches of the switching circuit 2 are driven through the second resistor R2, specifically turning on the first lower switch Q2 and the second upper switch Q3. Consequently, the following formula may be obtained:

$$V\_PWM \_CON 1 = V c 1 + V gs$$

In the above formula, V_PWM_CON1 is the voltage value of the first control signal PWM_CON1, Vel is the capacitor voltage of the first capacitor C1, and Vgs is the gate-source voltage of the first lower switch Q2 or the second upper switch Q3, wherein the gate-source voltage Vgs is the first switching signal PWM1. Obviously, the first switching signal PWM1 is a positive voltage in this time interval.

The time interval between the time point t1 and the time point t2 is the dead time Td of the first control signal PWM_CON1 and the second control signal PWM_CON2. Moreover, the first control signal PWM_CON1 and the second control signal PWM_CON2 are in the low level state. Since the capacitor voltage can not change instantaneously, the first capacitor C1 discharges slowly. Meanwhile, the gate-to-source voltages of the first lower switch Q2 and the second upper switch Q3 turn negative. In addition, the amplitude of the gate-source voltage is equal to the capacitor voltage of the first capacitor C1 and is expressed by the following formula:

$$- V c 1 + V gs$$

In the above formula, the first switching signal PWM1 is a negative voltage.

In the time interval between the time point t1 and the time point t2, the third capacitor C3 also discharges, resulting in a gradual decrease in the capacitor voltage Vc3 of the third capacitor C3. This drop turns on the first auxiliary switch Q5. For example, the first auxiliary switch Q5 is a PNP transistor or a MOS transistor. Since the first auxiliary switch Q5 is turned on in the time interval between the time point t2 and the time point t3, the gate-source voltages of the first lower switch Q2 and the second upper switch Q3 are pulled down to near zero voltage. Meanwhile, the first diode D1 may prevent abrupt discharge of the capacitor voltage Vc1 of the first capacitor C1, suppressing oscillations. Consequently, the main switches of the switching circuit 2 may avoid false turn-on.

In the time interval between the time point t3 and the time point t4, the first upper switch Q1 and the second lower switch Q4 cooperate with the second auxiliary switch Q6 to repeat the operations similar to those in the time interval between the time point t1 and the time point t2. Consequently, a switching cycle is completed.

The operations of the second driver 13, the second negative voltage generating circuit 14 and the second negative voltage control circuit 15a are similar to those of the first driver 10, the first negative voltage generating circuit 11 and the first negative voltage control circuit 12a. The operations of the second driver 13, the second negative voltage generating circuit 14 and the second negative voltage control circuit 15a can be easily understood from the waveforms of FIG. 6, and not redundantly described herein. Furthermore, the changes of the capacitor voltage Vel of the first capacitor C1, the capacitor voltage Vc2 of the second capacitor C2, the capacitor voltage Vc2 of the third capacitor C3 and the capacitor voltage Vc4 of the fourth capacitor C4 are also shown in FIG. 6.

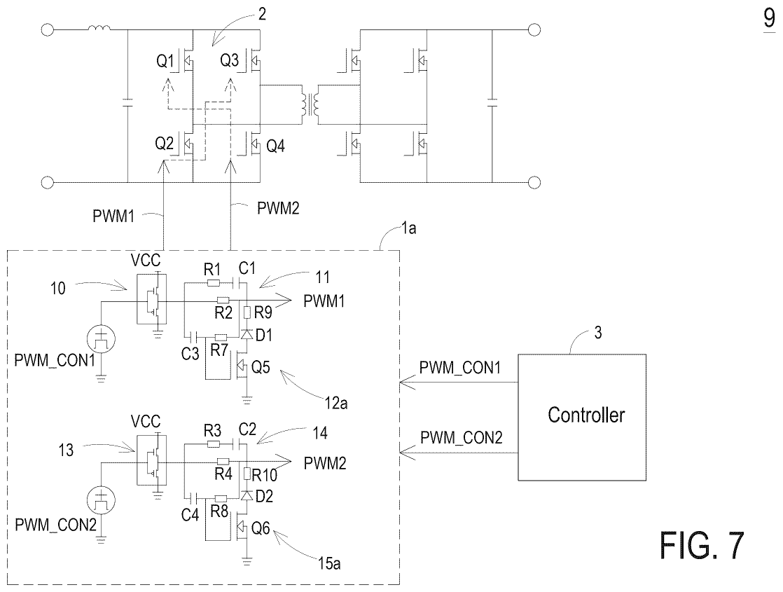

FIG. 7 is a schematic circuit diagram illustrating the circuitry topology of a power conversion device with a driving circuit according to a fourth embodiment of the present disclosure. The first negative voltage control circuit 12a further includes a ninth resistor R9. The ninth resistor R9 is connected in series with the first diode D1 and the first auxiliary switch Q5. In this embodiment, the ninth resistor R9 is electrically connected between the second terminal of the first negative voltage generating circuit 11 and the cathode of the first diode D1. Due to the installation of the ninth resistor R9, the slope during the transition of the first switching signal PWM1 from negative voltage to zero voltage can be adjusted to prevent voltage oscillation.

The second negative voltage control circuit 15a further includes a tenth resistor R10. The tenth resistor R10 is connected in series with the second diode D2 and the second auxiliary switch Q6. The tenth resistor R10 is electrically connected between the fourth terminal of the second negative voltage generating circuit 14 and the cathode of the second diode D2. Due to the installation of the tenth resistor R10, the slope during the transition of the second switching signal PWM2 from negative voltage to zero voltage can be adjusted to prevent voltage oscillation.

From the above descriptions, the present disclosure provides the driving circuit. In response to the negative voltage, the main switches in the switching circuit can be promptly turned off. Consequently, the main switches of the switching circuit may avoid false turn-on. Since the main switches are turned off in response to the negative voltage and the driving circuit promptly transitions the negative voltage to the zero voltage, the additional loss (reverse conduction loss) may be reduced, and the conversion efficiency of the power conversion device may be enhanced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A driving circuit for a power conversion device, the power conversion device comprising a switching circuit and a controller, the switching circuit comprising a plurality of main switches, the controller providing a first control signal and a second control signal to the driving circuit, the first control signal and the second control signal being complementary to each other, a dead time existing between the first control signal and the second control signal, the driving circuit comprising:
a first driver configured to receive the first control signal and generate a first driving signal;
a first negative voltage generating circuit comprising a first terminal, a second terminal, a first resistor, a first capacitor and a second resistor, wherein the first terminal is electrically connected to an output terminal of the first driver, the first resistor and the first capacitor are electrically connected in series between the first terminal and the second terminal to form a first series branch, the second resistor is connected in parallel with the first series branch, and a first switching signal is output from the second terminal of the first negative voltage generating circuit to control the operation of one part of the plurality of main switches of the switching circuit; and
a first negative voltage control circuit comprising a first diode and a first auxiliary switch, wherein the first diode and the first auxiliary switch are electrically connected in series between the second terminal of the first negative voltage generating circuit and a ground terminal,
wherein when the first control signal is transitioned from a high level state to a low level state, the first switching signal is transitioned from a positive voltage to a negative voltage by the first negative voltage generating circuit,
wherein following the dead time, the first switching signal is transitioned from the negative voltage to a zero voltage by the first negative voltage control circuit.

2. The driving circuit according to claim 1, wherein a control terminal of the first auxiliary switch is configured to receive the second control signal, wherein following the dead time, the second control signal is transitioned from the low level state to the high level state, and the first auxiliary switch is turned on, enabling the first switching signal to transition from the negative voltage to the zero voltage.

3. The driving circuit according to claim 1, further comprising:
a second driver configured to receive the second control signal and generate a second driving signal;
a second negative voltage generating circuit comprising a third terminal, a fourth terminal, a third resistor, a second capacitor and a fourth resistor, wherein the third terminal is electrically connected to an output terminal of the second driver, the third resistor and the second capacitor are electrically connected in series between the third terminal and the fourth terminal to form a second series branch, wherein the fourth resistor is connected in parallel with the second series branch, and a second switching signal is output from the fourth terminal of the second negative voltage generating circuit to control the operation of another part of the plurality of main switches of the switching circuit; and
a second negative voltage control circuit comprising a second diode and a second auxiliary switch, wherein the second diode and the second auxiliary switch are electrically connected in series between the fourth terminal of the second negative voltage generating circuit and the ground terminal,
wherein when the second control signal is transitioned from the high level state to the low level state, the second switching signal is transitioned from the positive voltage to the negative voltage by the second negative voltage generating circuit,
wherein following the dead time, the second switching signal is transitioned from the negative voltage to the zero voltage by the second negative voltage control circuit.

4. The driving circuit according to claim 3, wherein a control terminal of the second auxiliary switch is configured to receive the first control signal, wherein following the dead time, the first control signal is transitioned from the low level state to the high level state, and the second auxiliary switch is turned on, enabling the second switching signal to transition from the negative voltage to the zero voltage.

5. The driving circuit according to claim 1, wherein the first negative voltage control circuit further comprises a fifth resistor, wherein the fifth resistor is electrically connected in series with the first diode and the first auxiliary switch.

6. The driving circuit according to claim 3, wherein the second negative voltage control circuit further comprises a sixth resistor, wherein the sixth resistor is electrically connected in series with the second diode and the second auxiliary switch.

7. The driving circuit according to claim 1, wherein the first negative voltage control circuit further comprises:
a third capacitor electrically connected between the first terminal of the first negative voltage generating circuit and a control terminal of the first auxiliary switch; and
a seventh resistor electrically connected between the second terminal of the first negative voltage generating circuit and the control terminal of the first auxiliary switch,
wherein when the first control signal is transitioned from the high level state to the low level state, the third capacitor discharges,
wherein following the dead time, the first auxiliary switch is turned on, enabling the first switching signal to transition from the negative voltage to the zero voltage.

8. The driving circuit according to claim 3, wherein the first negative voltage control circuit further comprises a third capacitor and a seventh resistor, and the second negative voltage control circuit further comprises a fourth capacitor and an eighth resistor, wherein the third capacitor is electrically connected between the first terminal of the first negative voltage generating circuit and a control terminal of the first auxiliary switch, the seventh resistor is electrically connected between the second terminal of the first negative voltage generating circuit and the control terminal of the first auxiliary switch, the fourth capacitor is electrically connected between the third terminal of the second negative voltage generating circuit and a control terminal of the second auxiliary switch, and the eighth resistor is electrically connected between the fourth terminal of the second negative voltage generating circuit and the control terminal of the second auxiliary switch, wherein when the first control signal is transitioned from the high level state to the low level state, the third capacitor discharges, wherein following the dead time, the first auxiliary switch is turned on, causing the first switching signal to transition from the negative voltage to the zero voltage, wherein when the second control signal is transitioned from the high level state to the low level state, the fourth capacitor discharges, wherein following the dead time, the second auxiliary switch is turned on, enabling the second switching signal to transition from the negative voltage to the zero voltage.

9. The driving circuit according to claim 8, wherein the first negative voltage control circuit further comprises a ninth resistor connected in series with the first diode and the first auxiliary switch.

10. The driving circuit according to claim 8, wherein the second negative voltage control circuit further comprises a tenth resistor connected in series with the second diode and the second auxiliary switch.

11. The driving circuit according to claim 1, wherein the plurality of main switches are gallium nitride switches.
